(19) United States
(12) Patent Application Publication
(10) Pub. No.: US 2002/0062173 A1
(43) Pub. Date: May 23, 2002

(54) Method and apparatus for operating a vending machine to divert charitable contributions

(76) Inventor: Michael S. Gzybowski, Fort Wayne, IN (US)

Correspondence Address: Michael S. Gzybowski, P.O. Box 13381, Fort Wayne, IN, 46868, US

(21) Appl. No.: 10/047,892

(22) Filed: Jan. 14, 2002

Related U.S. Application Data
(63) Continuation of application No. 09/536,654, filed on Mar. 27, 2000.

(51) Int. Cl. G06F 17/00

(52) U.S. Cl. 700/232

(57) ABSTRACT

A method of soliciting charitable contributions from customers who are parties in a sales transaction involving a vending machine. The transaction involves soliciting a small sum of money, such as change from a sales transaction, before the sales transaction is completed.

### TECHNICAL FIELD

The present invention relates to vending machines that are used to receive money and dispense various items, including food and beverage products. More particularly, the present invention is directed to vending machines that solicit, divert and retain funds for charitable contributions.

### BACKGROUND ART

It is well known in the prior art to dispense beverages, e.g., cans of soft drinks, from a coin-operated vending machine. Coin-operated vending machines also are used to dispense packages of food products, e.g., candy, snack foods such as potato chips or pretzels, or sandwiches. In addition, non-food and non-beverage items, including batteries, toiletries, etc. are dispensed in vending machines.

Vending machines typically comprise devices for storing goods to be dispensed, cash receiving devices for receiving cash deposits from a user, cash calculating devices for determining the value of the cash deposited by the user, goods pricing devices for determining the price of a particular good selected by the user, comparator devices for comparing the value of the cash deposited by the user with the price of the good selected by the user, and dispensing apparatus for dispensing the selected good if the user has deposited sufficient cash and for dispensing cash if change is required. Vending machines may also include devices for detecting certain conditions, such as out-of-stock, jam or unauthorized entry.

A modern vending machine can have a variable number of product selection buttons, a variable number of supply columns, supply columns of different capacities, and the capability to assign columns to buttons. For example, multiple supply columns may be assigned to the same button. Typically, each selection button is associated with a single product, of which multiple items are available for sale. Thus, it is possible to provide various capacities for various products.

By way of example, a typical cold drink dispensing vending machine has from six to twelve selection buttons, but from six to twenty supply columns, with each supply column having a capacity of from 15 to 65 items of the product.

Vending machines for selling merchandise, such as cans of soft drinks, are well known in the art. Generally speaking, conventional vending machines include a vending unit, a payment unit and a control unit for coordinating therebetween.

Typically, the vending unit includes a storage unit for storing an inventory of articles to be vended and a dispensing unit for dispensing the purchased article. Alternatively, the dispensing unit may be replaced by a unit which provides selective access to a preselected article, such as described in U.S. Pat. Nos. 4,893,705 and 5,133,441, both to Brown.

In prior art vending machines, purchasing an item typically involves the following four operations:

1. depositing a sum of money using either cash or a payment card;

2. selecting an item to be purchased by employing a mechanical lever, a keypad or a touch screen;

3. receiving the purchased item vended by a dispensing unit or receiving selective access to the preselected item; and

4. retrieving change for the unused portion of the deposited cash sum or the payment card.

Processor-based prior art vending machine controllers (VMCs) typically have been implemented using a low cost, embedded controller, e.g., the Intel brand model 8051. Such a controller separately performs many vending machine control operations, including monitoring, storing, and periodically reporting data pertinent to the operation of the vending machine, e.g., sales and inventory information.

Conventional vending machines also have mechanical arrangements that permit return change to be handled in a variety of different ways. A variety of different techniques and devices for handling change are already well-known in the conventional art, as are various devices for storing the change.

U.S. Pat. No. 4,776,548 exemplifies a system for monitoring a vending machine and periodically transmitting information relating to machine conditions, sales and product inventory to a central computer.

Accordingly, a need exists for a vending machine that will use existing mechanical vending machine devices and re-program controllers in order to identify and allocate funds for charity taken from change normally offered in vending machines. Such a system will provide for a solicitation of the change, the identification of the charity, a decision by the user, indication of the user's desire for the change, and the allocation of the identified funds from change originally allocated to the user.

### DISCLOSURE OF THE INVENTION

According to various features, characteristics and embodiments of the present invention which will become apparent as the description thereof proceeds, the present invention provides a vending machine which includes:

a storage area for storing items offered for sale;

means for receiving cash from a customer desiring to purchase one or more of the stored items;

means for the customer to select an item to be purchased from said stored items;

means for dispensing a selected item to the customer;

means for calculating any change due to the customer after a selected item is purchased;

means for prompting the customer as to whether the customer would like to donate any change due to a charity; and

means for returning any change due if the customer chooses not to donate the change and for retaining the change if the customer chooses to donate it.

The present invention further provides for a method of receiving charitable contributions which involves the steps of:

a) offering a customer an item for sale;

b) receiving cash from the customer to buy said item;

c) calculating any change due to the customer from the sale of the item;

d) before returning any change to the customer, offering the customer a choice between donating any change due to a charity or having the change returned;

e) retaining any change that the customer chooses to donate and returning any change that the customer chooses not to donate.

According to one embodiment, this method utilizes a vending machine to perform each of steps a) through e).

The present invention also provides an improvement for vending machines which receive cash from purchasers and dispense items in exchange for received cash, the improvement comprising:

means for prompting customers as to whether they would like to donate any change due to a charity; and

means for returning any change due to any customer who chooses not to donate the change and for retaining the change from any customer who chooses to donate it.

The present invention also provides a method of receiving charitable contributions which involves the steps of:

a) offering a customer an item for sale;

b) receiving and electronic equivalent of cash from the customer to buy said item;

c) before finalizing said sale, offering the customer a choice between donating an additional electronic equivalent of cash to a charity or finalizing the sale;

d) retaining any additional electronic equivalent of cash that the customer chooses to donate and finalizing the sale.

### BRIEF DESCRIPTION OF DRAWINGS

The present invention will be described with reference to the attached drawing which are given as non-limiting examples only, in which:

FIG. 1 is a flow chart which exemplifies the steps that a customer using a vending machine would take according to the present invention.

FIG. 2 is a flow chart which indicates one embodiment directed to the operation of a vending machine according to the present invention.

### BEST MODE FOR CARRYING OUT THE INVENTION

The present invention relates to vending machines that are used to receive money and dispense various items, including, but not limited to, food and beverage products. More particularly, the present invention is directed to vending machines that solicit and retain charitable contributions.

The present invention provides vending machines that display items that are offered for sale, receive and sum moneys from a purchaser, provide devices for the purchaser to select a desired item, provide devices for dispensing a selected item, display change due to the purchaser, prompt the customer as to if he or she would like to donate the change due to a referenced charity, and either return the customer's change due or retain the change due, depending on the customer's choice.

According to a further embodiment of the present invention, the vending machine can prompt the customer as to if he or she would like to donate all or a portion of the change due to the referenced charity. The portion can be a percentage of the change due or a set amount which is smaller than the change due.

According to another embodiment of the present invention, the vending machine can offer the customer a number of charities to which the change due can be retained (and credited) for. Alternatively, the vending machine can be programed and configured to allow the customer to apportion the change due to more than one charity.

Upon retention of a donation of the change due, the vending machine can display a “Thank-you” sign and/or produce an audible “Thank-you.”

The principles of the present invention are applicable to conventional vending machines that are designed to dispense food products, beverages, as well as non-food items and/or non-beverage items.

The present invention is particularly compatible with conventional vending machines that include controllers, e.g. computers, processors, micro chips, etc., comparators or other circuitry that tally monies received and calculates change due, and ideally provide for accounting of moneys retained.

Adapting such known types of vending machines to the principles of the present invention, involves including a step and supporting devices for prompting customers as to if they would like to donate any change due to a referenced or identified charity, and providing means, such as a selection button, keypad, touch panel, etc., by which customers can choose to donate or be refunded their change. Vending machines which have accounting and/or inventory systems could easily be programmed to account for donated monies. Vending machines that do not include conventional accounting and/or inventory systems could be provided with such systems.

One concept behind the present invention is to receive change which is typically a small amount and in the form of coins that people empty out of their pockets at home into a “change jar” to which no significant importance is placed. The concept of prompting the customers of vending machines to donate their change before they even receive it in their own hands, would provide an efficient manner of raising large sums of money for charitable purposes when considering the number of vending machines that are currently in use.

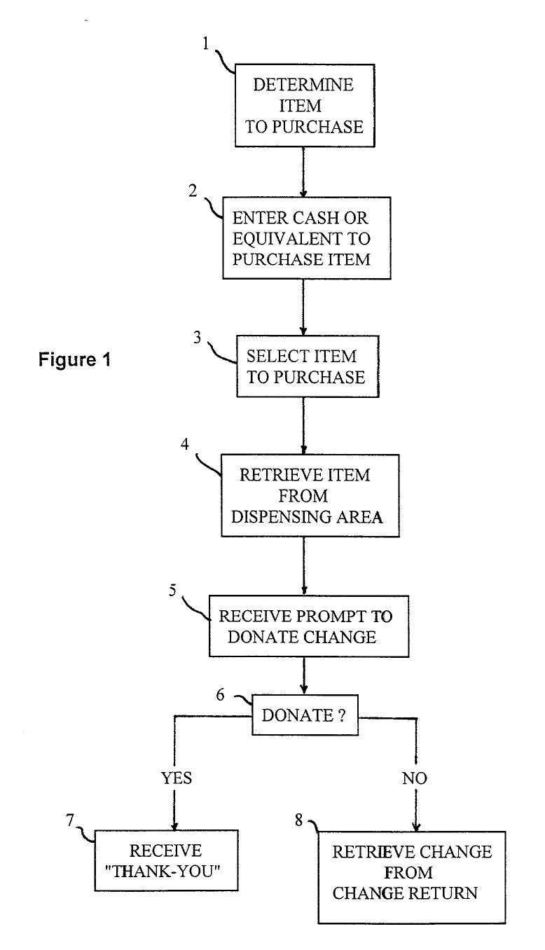

FIG. 1 is a flow chart which exemplifies the steps that a customer using a vending machine would take according to the present invention.

In step 1 a customer of a vending machine determines which item(s) to purchase. To aid in this determination, the vending machine either physically displays items which are offered for sale, such as candy bars, gum, packaged foods, beverage containers, etc. or pictorially, graphically, textually, etc. displays items that are offered for sale. The vending machine likewise displays the purchase price of each item in a conventional manner. It is within the scope of this invention for a customer to purchase more than one item from a vending machine by adding at least a sufficient amount of cash (or equivalent) to cover any desired purchases.

After determining which item(s) to purchase, the customer enters cash or an equivalent of case at step 2 to purchase a desired item(s). The form of cash would most probably be coins or paper denominations of currency. Alternatively, the vending machine could be configured to receive any equivalent of cash, including credit or debt cards, pre-paid cards, tokens, electronic cash transactions, etc. It is also within the scope of the present invention to have the vending machine receive a cash input that causes an identified account to be billed or debited for purchases. In general, any form of payment could be used according to the present invention.

As discussed below, the vending machine preferably includes a display which shows the amount of cash which has been inputted by the customer.

In step 3, the customer selects an item(s) to be purchased. This can be achieved according to any conventional means such as by pressing a button, electronic touch pad, entering a code from a combination of numeric and alphabetic buttons, keypad, touch pad, etc., pulling a lever or manipulating any equivalent selector, etc.

In response to the action taken by the customer in step 3, the vending machine dispenses the purchased item(s) in a conventional manner to an item retrieval area which, for example, can be a bin with or without a cover.

In step 4, the customer retrieves the purchased item(s) from the vending machine.

As discussed in detail below, the vending machine displays both the cash inputted by the customer and the amount of change remaining after a purchase transaction. After the customer completes step 3, as discussed below, the vending machine displays the amount of change due to the customer and a prompt (in step 5) asking the customer if he or she would like to donate the change due to a charity. The charity could be pre-identified or the identify of the charity would be displayed on or near the vending machine in some convenient manner.

In response to the prompt in step 5, step 6 is a decision step in which the customer decides whether he or she wants to donate the change due from the vending machine. If the customer decides to donate the change due, the vending machine acknowledges the decision and can display a “Thank-You” either visually or audibly (shown as step 7). If the customer decides not to donate the change due, the vending machine dispenses the change due to a change return area, and the customer retrieves the change in Step 8.

The flow chart depicted in FIG. 1 exemplifies the general order of the various steps. It is to be understood that the order of some of the steps could be changed. For example, the order of steps 1 and 2 could be reversed. In this regard, it is not uncommon for a purchaser to enter cash into a vending machine and thereafter determine what item(s) to purchase. It is also possible to retrieve purchased items after change is returned. Accordingly, step 4 could occur after step 5 or after either of steps 7 or 8.

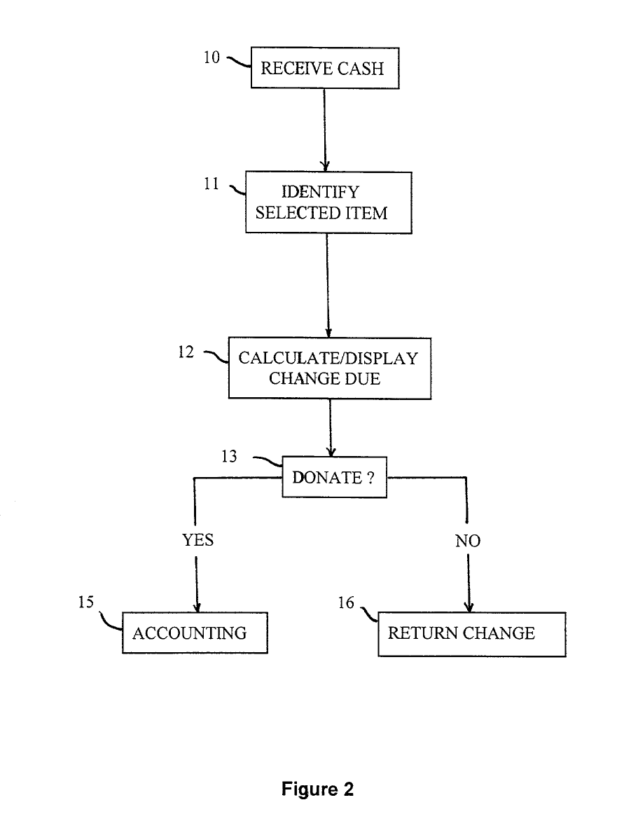

FIG. 2 is a flow chart which depicts one embodiment of the invention directed to operation of a vending machine according to the present invention.

The operation of the vending machine and the steps that a customer takes (exemplified in FIG. 1) are necessary coordinated inasmuch as there is interaction between the customer and the vending machine.

In step 10 in FIG. 2, the vending machine receives the cash (or equivalent thereof) that the customer enters in step 2 of FIG. 1. As discussed above, the form of cash would most probably be coins or paper denominations of currency. However, the vending machine could be configured to receive any equivalent of cash, including credit or debt cards, pre-paid cards, tokens, electronic cash transactions, etc. It is also within the scope of the present invention to have the vending machine receive a cash input that causes an identified account to be billed or debited for purchases. In general, any form of payment could be used according to the present invention.

In order to assist customers who enter increments of cash or equivalent thereof, the vending machine can calculate and display the accumulated sum of the cash added. Means for identifying increments of cash, such as different coin denominations, and calculating and displaying the accumulated sum of cash (or equivalent) received by vending machines are known and can be incorporated for use in conjunction with the present invention.

In response to step 3 in FIG. 1, in step 11 in FIG. 2 the vending machine identifies the item(s) selected for purchase by the customer. The identify of the item(s) selected for purchase by the customer is used by the vending machine in a conventional manner to determine the cost of the item(s) and the location for purposes of dispensing the item(s).

Following step 11, the vending machine uses conventional technology to determine whether a sufficient amount of cash (or equivalent) has been received to purchase the selected item(s). If not, vending machines typically prompt the customer to enter additional cash (or equivalent) or advise the customer, by a display, that insufficient cash (or equivalent) as been received. In accordance with other known vending machine functions, upon selecting an item, the vending machine can advise the customer that the item is sold out.

If sufficient cash (or equivalent) has been received to cover the purchase of a selected item(s), the vending machine will dispense the item(s) in a conventional manner and will utilize conventional technology to calculate any change due the customer.

According to the present invention, upon determination that change is due the customer after a purchase, the vending machine displays the amount of change due in step 12 and, in step 13, prompts the customer, asking if the customer would like to donate the change due to a charity. The calculation and display of any change due can utilize conventional controllers, e.g. computers, processors, micro chips, etc. Likewise, the prompting to solicit donation of the customer's change due can be accomplished by simple programming of conventional controllers, e.g. computers, processors, micro chips, etc.

After prompting the customer in step 13, the vending machine receives input from the customer in step 14. Such input, which is the customer's decision to donate his or her change due or not to donate it, can be input in any convenient manner including alternative decision buttons, touch pads, etc. According to an alternative embodiment, the vending machine can have a default setting by which the customer's change due is either retained or returned based upon an input by the customer.

If the customer donates his or her change due by proper input in step 6 of FIG. 1, as discussed above, the vending machine can display a “Thank-you” sign and/or an audible “Thank-you.” Otherwise, if the customer decides to keep his or her change due, the vending machine returns the customer's change due in a conventional manner in step 16.

Step 15 in FIG. 2 represents an accounting function. The use of accounting means in vending machines to coordinate inventory with sales is known. According to the present invention, such accounting means can be easily modified to track change due from purchases that is donated by customers. For example, the donated change can be simply correlated as an item offered for purchase by the vending machine. Conventional accounting means which also track inventories would merely have to identify the donated money as being applied to purchase an additional item. Alternatively, accounting means that merely supplies a final total for cash received and inventory sold (for example when the vending machine is serviced/stocked) could be used to determine the amount of monies donated, without having to keep an accrued ledger of donated monies.

The particular charity to which the monies are donated can be pre-identified or the identify of the charity would be displayed on or near the vending machine in some convenient manner. An example of a pre-identified charity would be an instance in which a product manufacturer, such as a soft drink manufacturer, would sponsor and promote a specific charity so that customers would associate the manufacturer's products (and vending machines) with that charity.

In an alternative embodiment, the vending machine could provides means by which a customer could select to donate change due to one or more charities. For example, upon being prompted to donate change due, the vending machine could provide a selection of charities which the customer could choose from. Selection of one or more of such charities could be accomplished in a similar manner to selecting an item to be purchased from the vending machine. Change donated could be equally portioned if two or more charities are selected. Alternatively, the vending machine could provide means by which the customer could portion donated monies between two or more charities.

In another alternative embodiment, the vending machine could allow a customer to donate a fixed or selectable portion of change due to one or more charities.

A concept of the present invention which involves in a broad sense soliciting charitable donations in conjunction with purchase transactions is believed to be well suited to vending machines, particularly in instances in which the amount of the customer's change might have little significance to the customer. A purchaser of a beverage or snack from a vending machine might have little or no interest in receiving $0.05- $0.15 or more back in change.

The broader concept noted above could also be used in conjunction with purchases made at cashier stations using either cash or non-cash forms of payment. Here the concept would be to obtain a small amount of “change” that does not pass through the customer's hands and which is solicited in a manner that is convenient and involves a perceived insignificant sum.

For example, the concept of the present invention could be applied to a method in which a customer who pays for his or her purchases with a credit card, debit card or other non-cash form or payment is prompted by the electronic card transaction system asking if the customer would like to donate a small amount such as the odd change needed to round off the sale to an even dollar amount. Alternatively, the customer could be prompted to donate a small, predetermined amount or allowed to choose and amount. Such electronic card transaction systems which are common place in retail stores are integrated into price scanning case registers, accounting systems and banking systems which can easily coordinate electronic cash donations. Such systems include card readers and input display screens which can be used to prompt customers for donations.

In a more general manner involving cash purchases, a cashier could ask (on behalf of a charity or sponsor) if the customer would like to donate a small amount such as the odd change needed to round off the sale to an even dollar amount. Alternatively, the customer could be prompted to donate a small, predetermined amount or allowed to choose an amount to donate.

The features, principles and concepts of the invention described herein can be adapted, if desired, to generate and provide customers with donation receipts, credits for promotional awards, discounts, charitable drawings, and other conventional charitable activities. However, in it's simplest embodiments the present invention merely seeks to collect “spare change” that customers may well be predispositioned to donate, particularly when they do not have to handle the change themselves and it is a small sum.

The present invention could also be applied to slot machines in which case, upon winning, the player would be prompted and asked if he or she would like to donate a portion of his or her winnings to a charity.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A vending machine which comprises:
a storage area for storing items offered for sale;
means for receiving cash from a customer desiring to purchase one or more of the stored items;
means for the customer to select an item to be purchased from said stored items;
means for dispensing a selected item to the customer;
means for calculating any change due to the customer after a selected item is purchased;
means for prompting the customer as to whether the customer would like to donate any change due to a charity; and
means for returning any change due if the customer chooses not to donate the change and for retaining the change if the customer chooses to donate it.

2. A vending machine according to claim 1, further comprising means for displaying the amount of any change due to the customer.

3. A vending machine according to claim 1, further comprising means for displaying an accrued amount of cash received into the means to receive cash.

4. A vending machine according to claim 1, further comprising means for the customer to select whether to donate any change due.

5. A vending machine according to claim 4, wherein said means for the customer to select whether to donate any change due comprises means to select from one of a plurality of charities.

6. A vending machine according to claim 4, wherein said means for the customer to select whether to donate any change due comprises means to select to donate all or a portion of any change due.

7. A vending machine according to claim 1, further comprising means for identifying an amount of monies donated by customers.

8. A vending machine according to claim 1, wherein said selected item comprises a food product.

9. A vending machine according to claim 1, wherein said food product comprises a beverage.

10. A method of utilizing a vending machine to receive charitable contributions which comprises the steps of:
a) offering a customer an item for sale;
b) receiving cash from the customer to buy said item;
c) calculating any change due to the customer from the sale of the item;
d) before returning any change to the customer, offering the customer a choice between donating any change due to a charity or having the change returned;
e) retaining any change that the customer chooses to donate and returning any change that the customer chooses not to donate,
wherein each of the steps a) through e) are performed by a vending machine.

11. A method of receiving charitable contributions according to claim 10, wherein step d) further comprises offering the customer to donate all or a portion of any change due to one of more charities.

12. A method of receiving charitable contributions according to claim 10, wherein step a) comprises offing the customer a plurality of items for sale from which the customer can choose between at least one or more of the items.

13. In a vending machine which receives cash from purchasers and dispenses items in exchange for received cash, the improvement comprising:
means for prompting customers as to whether they would like to donate any change due to a charity; and
means for returning any change due to any customer who chooses not to donate the change and for retaining the change from any customer who chooses to donate it.

14. A vending machine according to claim 13, further comprising means for customers to select between one or more charities to donate any portion of their change due.
